(19) United States
(12) Patent Application Publication
(10) Pub. No.: US 2026/0016888 A1
(43) Pub. Date: Jan. 15, 2026

(54) IMAGE DISPLAY DEVICE AND ELECTRONIC DEVICE INCLUDING THE SAME

(71) Applicant: Samsung Display Co., LTD., Yongin-si (KR)

(72) Inventor: Seung Jun LEE, Yongin-si (KR)

(21) Appl. No.: 19/052,742

(22) Filed: Feb. 13, 2025

(30) Foreign Application Priority Data
Jul. 12, 2024 (KR) 10-2024-0092284

(51) Int. Cl. G06F 3/01; G09G 3/20

(52) U.S. Cl. CPC G06F 3/013; G09G 3/2007; G09G 2320/0626; G09G 2320/0686; G09G 2354/00

(57) ABSTRACT

An image display device includes: a display panel configured to display an image in an image display area; a gaze tracking processor configured to analyze image data for an image on a front side captured by a built-in camera of the display panel and to detect gaze tracking coordinate information; and a main driver circuit configured to divide and separate the image display area into a plurality of divided display areas based on the gaze tracking coordinate information, and to modulate a grayscale value or a luminance value of the image data for at least one of the divided display areas according to still image or moving image features to thereby control an image display operation for at least one of the divided display areas.

### CROSS-REFERENCE TO RELATED APPLICATION

The present application claims priority to and the benefit of Korean Patent Application No. 10-2024-0092284, filed on Jul. 12, 2024, in the Korean Intellectual Property Office, the entire disclosure of which is incorporated herein by reference.

### BACKGROUND

### 1. Field

Aspects of some embodiments of the present disclosure relate to an image display device.

### 2. Description of the Related Art

As the information-oriented society has evolve, consumer demand for display devices is ever increasing. For example, display devices may be utilized by a variety of electronic devices such as smart phones, digital cameras, laptop computers, navigation devices, and smart televisions.

A display device may be a flat-panel display device such as a liquid-crystal display device, a field emission display device, and an organic light-emitting display device. Among such flat-panel display devices, an organic light-emitting display device includes a light-emitting element that can emit light on its own, so that each of the pixels of the display panel can emit light by themselves. Accordingly, a light-emitting display device can display images without a backlight unit that supplies light to the display panel.

Recently, various types of display devices that can selectively adjust the image display area, unlike simple flat display devices, have been developed. For example, a variety of types of flexible display devices with adjustable image display screens, such as foldable display devices, rollable display devices, bendable display devices, curved display devices and stretchable display devices, are under development. In addition, laptop computers, tablet PCs, etc., may be used as portable display devices even with relatively large screens.

The above information disclosed in this Background section is only for enhancement of understanding of the background and therefore the information discussed in this Background section does not necessarily constitute prior art.

### SUMMARY

Aspects of some embodiments of the present disclosure include a display device that can track and analyze a user's gaze direction and modulate image display characteristics, such as brightness and luminance, for each image display area on a large screen along the user's gaze direction.

Aspects of some embodiments of the present disclosure include a display device that can divide and separate image display areas in real time based on results of tracking a user's gaze direction and modulate image display characteristics by applying different weights to different image display areas based on features of still images or moving images.

It should be noted that the characteristics of embodiments according to the present disclosure are not limited to the above-mentioned characteristics; and other characteristics of embodiments according to the present disclosure will be apparent to those skilled in the art from the following descriptions.

According to some embodiments of the present disclosure, an image display device includes: a display panel for displaying an image in an image display area, a gaze tracking processing unit for analyzing image data for an image on a front side captured by a built-in camera of the display panel and detecting a user's gaze tracking coordinate information, and a main driver circuit for dividing and separating the image display area into a plurality of divided display areas based on the gaze tracking coordinate information, and modulating a grayscale value or a luminance value of the image data for at least one of the divided display areas according to still image or moving image features to thereby control an image display operation for at least one of the divided display areas.

According to some embodiments of the present disclosure, an image display device includes: a display panel for displaying an image in an image display area, a touch sensor on a front surface of the display panel to detect a user's touch, a gaze tracking processing unit for analyzing image data on an image on a front side captured by a built-in camera of the display panel and detecting the user's gaze tracking coordinate information; and a main driver circuit for dividing and separating the image display area into a gaze area corresponding to the gaze tracking coordinates, at least one adjacent area adjacent to the gaze area, at least one distant area separated from the gaze area with the at least one adjacent area therebetween, and at least one important display area displaying an image of an important feature depending on characteristics of the displayed image, and modulates image data for at least one divided display area angle the divided display areas to control an image display operation for the at least one divided display area.

According to some embodiments of the present disclosure, an electronic device includes: an image display device, wherein the image display device comprising a display panel for displaying an image in an image display area, a gaze tracking processing unit for analyzing image data for an image on a front side captured by a built-in camera of the display panel and detecting a user's gaze tracking coordinate information, and a main driver circuit for dividing and separating the image display area into a plurality of divided display areas based on the gaze tracking coordinate information, and modulating a grayscale value or a luminance value of the image data for at least one of the divided display areas according to still image or moving image features to thereby control an image display operation for at least one of the divided display areas.

According to some embodiments of the present disclosure, a display device divides the entire image display area into a plurality of display areas based on results of tracking a user's gaze, and modulates the image display characteristics such as brightness and luminance for each of the plurality of display areas, thereby reducing power consumption for each of the display areas.

In addition, according to some embodiments of the present disclosure, by applying different weights to different divided display areas depending on whether the displayed image is a still image or a moving image to modulate the image display characteristics, it may be possible to increase the efficiency of saving power consumption of a display device while reducing the user's effort of perception.

It should be noted that effects of the present disclosure are not limited to those described above and other characteristics of embodiments according to the present disclosure will be apparent to those skilled in the art from the following descriptions.

### BRIEF DESCRIPTION OF THE DRAWINGS

The above and other aspects and characteristics of embodiments according to the present disclosure will become more apparent by describing in more detail aspects of some embodiments thereof with reference to the attached drawings, in which:

FIG. 1 is a perspective view showing a foldable image display device according to some embodiments of the present disclosure.

FIG. 2 is a perspective view showing an image display surface of a foldable image display device according to some embodiments of the present disclosure.

FIG. 3 is a plan view showing in more detail aspects of elements of a display device according to some embodiments of the present disclosure.

FIG. 4 is a cross-sectional view showing further detail aspects of the elements of the display device shown in FIG. 3.

FIG. 5 is a view showing an example of a layout of a display panel according to some embodiments of the present disclosure.

FIG. 6 is a block diagram showing further details the elements of the main driver circuit shown in FIGS. 3 and 4.

FIG. 7 is a flowchart for illustrating aspects of a method for correcting image data for each of the image display areas and modulating image display characteristics according to some embodiments of the present disclosure.

FIG. 8 is a perspective view showing a plurality of divided display areas separated on the image display areas of FIGS. 2 and 3 according to some embodiments.

FIG. 9 is a perspective view showing a plurality of divided display areas separated on the image display areas of FIGS. 2 and 3 according to some embodiments.

FIG. 10 is a graph showing reduction ratios of the brightness for different divided display areas according to still image features.

FIG. 11 is a graph showing reduction ratios of the brightness for different divided display areas according to still image features.

### DETAILED DESCRIPTION

Aspects of some embodiments of the present disclosure will now be described more fully hereinafter with reference to the accompanying drawings, in which aspects of some embodiments of the present disclosure are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Each of the features of the various embodiments of the present disclosure may be combined or combined with each other, in part or in whole, and technically various interlocking and driving are possible. Each embodiment may be implemented independently of each other or may be implemented together in an association.

Hereinafter, aspects of some embodiments of the present disclosure will be described in more detail with reference to the accompanying drawings.

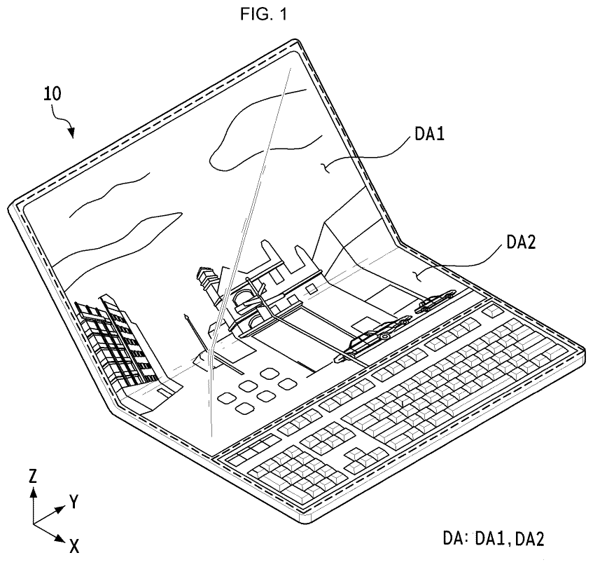

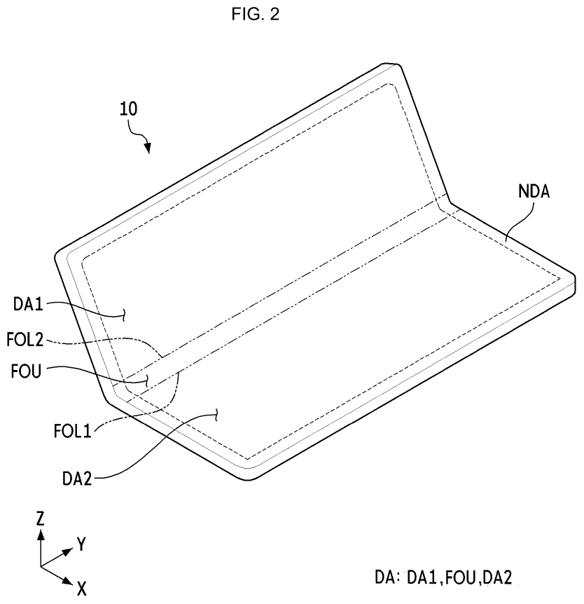

FIG. 1 is a perspective view showing a foldable image display device according to some embodiments of the present disclosure. FIG. 2 is a perspective view showing an image display surface of a foldable image display device according to some embodiments of the present disclosure.

Referring to FIGS. 1 and 2, an image display device (hereinafter referred to as a display device 10) according to some embodiments of the present disclosure may be employed by portable electronic devices such as a mobile phone, a smart phone, a tablet PC, a mobile communications terminal, an electronic notebook, an electronic book, a portable multimedia player (PMP), a navigation device and a ultra mobile PC (UMPC). Alternatively, the display device 10 according to some embodiments of the present disclosure may be used as a display unit of a television, a laptop computer, a monitor, an electronic billboard, or the Internet of Things (IOT).

As used herein, the first direction (x-axis direction) may be the shorter side direction of the display device 10, for example, the horizontal direction of the display device 10. In addition, the first direction may be a shorter-side direction of the folded display device 10. The second direction (y-axis direction) may be the longer-side direction of the display device 10, for example, the vertical direction of the display device 10. The second direction (y-axis direction) may be the longer-side direction of the folded display device 10. A third direction (z-axis direction) may refer to the thickness direction of the display device 10.

In the example shown in FIGS. 1 and 2, the display device 10 according to some embodiments of the present disclosure is a foldable display device that can be folded once in the first direction (x-axis direction). The display device 10 may be transformed into between a folding state in which it is folded once, a flexed state in which it is bent at a predetermined angle and a flat state in which it is fully unfolded, or may be held in one of the states. The display device 10 may be implemented as a flat-panel display device in a flat state and may be applied as a display unit of laptop computers or tablet PCs. Applications of the display device 10 according to the present disclosure are not limited to the embodiments of the present disclosure.

Referring to FIG. 2, the image display area DA of the display device 10 on the front side may be divided into at least one image display area (e.g., first and second image display areas DA1 and DA2) and at least one folding area FOU. Therefore, when the display device 10 is unfolded as in FIG. 2, images may be displayed on the front side in the first and second image display areas DA1 and DA2 and the folding area FOU of the display device 10. A non-display area NDA may be formed at the borders (e.g., in a periphery or outside a footprint) of at least one folding area FOU and the first and second display areas DA1 and DA2.

For example, the first image display area DA1 may be located on one side of the folding area FOU, e.g., on the right side of the folding area FOU. In addition, the second image display area DA2 may be located on the opposite side of the folding area FOU, e.g., on the left side of the folding area FOU. The folding area FOU and first and second folding lines FOL1 and FOL2, which are the boundaries of the folding area FOU may be extended in the second direction (y-axis direction), and the display device 10 may be folded in the first direction (x-axis direction).

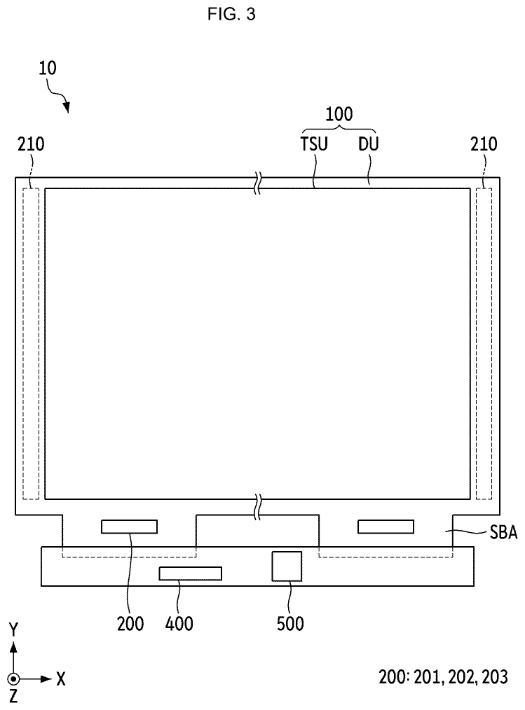

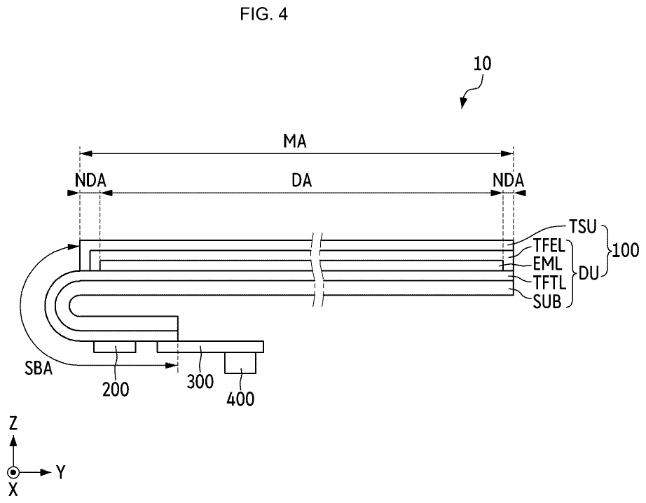

FIG. 3 is a plan view showing further detail of some elements of a display device according to some embodiments of the present disclosure. FIG. 4 is a cross-sectional view showing in detail the elements of the display device shown in FIG. 3.

Referring to FIGS. 3 and 4, a display device 10 according to some embodiments may be sorted into a variety of devices depending on the way how images are displayed. For example, the display device 10 may be classified into and implemented as an organic light-emitting display device (OLED), an inorganic light-emitting display device (inorganic EL), a quantum-dot light-emitting display device (QED), a micro LED display device (micro-LED), a nano LED display device (nano-LED), a plasma display device (PDP), a field emission display device (FED), a liquid-crystal display device (LCD), an electrophoretic display device (EPD), etc. In the following description, an organic light-emitting display device (OLED) will be described as an example of the display device. The organic light-emitting display device OLED will be simply referred to as the display device 10 unless it is necessary to distinguish between them. It is, however, to be understood that the embodiments of the present disclosure are not limited to the organic light-emitting display device (OLED), and one of the above-listed display devices or any other display device well known in the art may be employed as the display device 10 without departing from the scope of the present disclosure.

As shown in FIGS. 3 and 4, the display panel 100 of the display device 10 includes an image display unit DU, a plurality of data driver circuits 200, a circuit board 300, a main driver circuit 400, a gaze tracking processor 500, and a touch sensing module.

The touch sensing module may further include a touch sensing unit TSU located on the front surface of the display panel 100, and at least one touch driver circuit that generates touch coordinate data of the touch sensing unit TSU. The touch driver circuit may be formed integrally with the main driver circuit 400. In such case, the main driver circuit 400 may generate touch coordinate data of the touch sensing unit TSU.

The display unit DU of the display panel 100 may include a plurality of pixels. Images may be displayed through the plurality of pixels. Each pixel may include red, green and blue pixels, or red, green, blue and white pixels.

The image display unit DU receives data signals (e.g., analog data voltages) from each of the data driver circuits 200 and gate signals from the main driver circuit 400. In addition, the image display unit DU may display images through a plurality of sub-pixels SP arranged in the image display area DA of the image display unit DU in response to the data and gate signals.

The display panel 100 may be divided into a main area MA and a subsidiary area SBA. The main area MA may include the first and second image display areas DA1 and DA2, the folding area FOU, and the non-display area NDA. Images are displayed through the pixels in the first and second flat display areas DA1 and DA2, and the folding area FOU.

The subsidiary area SBA may be extended from one side of the main area MA. The subsidiary area SUB may include a flexible material that can be bent, folded, or rolled. For example, when the subsidiary area SBA is bent, the subsidiary area SBA may overlap the main area MA in the thickness direction (z-axis direction). The subsidiary area SBA may include pads connected to the main driver circuit 400 and the circuit board 300. Optionally, the subsidiary area SBA may be eliminated, and the main driver circuit 400 and the pads may be located in the non-display area NDA.

The circuit board 300 may be attached on the pad area of the display panel 100 using an anisotropic conductive film (ACF). Lead lines of the circuit board 300 may be electrically connected to the pads of the display panel 100. The circuit board 300 may be a flexible printed circuit board (FPCB), a printed circuit board (PCB), or a flexible film such as a chip-on-film (COF).

Incidentally, the substrate SUB of the display panel 100 shown in FIG. 4 may be a base substrate or a base member. The substrate SUB may be of a flat type. Alternatively, the substrate SUB may be a flexible substrate that can be bent, folded, or rolled. For example, the substrate SUB may include, but is not limited to, a glass material or a metal material. As another example, the substrate SUB may include a polymer resin such as polyimide PI.

The thin-film transistor layer TFTL may be located on the substrate SUB. The thin-film transistor layer TFTL may include a plurality of thin-film transistors forming pixel circuits of the pixels. The thin-film transistor layer TFTL may include gate lines, data lines, voltage lines, gate control lines, fan-out lines for connecting the data driver circuit 200 with the data lines, and lead lines for connecting the data driver circuit 200 with the pads. When the gate driver 210 is formed on one side and the opposite side of the non-display area NDA of the display panel 100, each gate driver 210 may also include thin-film transistors.

The thin-film transistor layer TFTL may be selectively arranged in the image display area DA, the non-display area NDA and the subsidiary area SBA. The thin-film transistors in each of the pixels, the gate lines, the data lines and the voltage lines in the thin-film transistor layer TFTL may be located in the image display area DA. The gate control lines and the fan-out lines in the thin-film transistor layer TFTL may be located in the non-display area NDA. The lead lines of the thin-film transistor layer TFTL may be located in the subsidiary area SBA.

The emission material layer EML may be located on the thin-film transistor layer TFTL. The emission material layer EML may include a plurality of light-emitting elements in each of which a first electrode, an emissive layer and a second electrode are stacked on one another sequentially to emit light, and a pixel-defining layer for defining the pixels. Light-emitting elements of the emission material layer EML may be arranged entirely in the display area DA.

An encapsulation layer TFEL may cover the upper and side surfaces of the emission material layer EML, and can protect the emission material layer EML. The encapsulation layer TFEL may include at least one inorganic layer and at least one organic layer for encapsulating the emission material layer EML.

The touch sensing unit TSU may be located on the encapsulation layer TFEL of the display panel 100. The touch sensing areas of the touch sensing unit TSU may include a plurality of touch electrodes for sensing a user's touch by capacitive sensing, and touch driving lines connecting the plurality of touch electrodes with at least one touch driver circuit or the main driver circuit 400. In each of the touch sensing areas, touch electrodes may be arranged in a matrix to sense a user's touch by self-capacitance sensing or mutual capacitance sensing.

The touch sensing unit TSU may not be formed integrally with the display panel 100 but may be located on a separate substrate or film located on the display unit DU of the display panel 100. In such case, the substrate of the film supporting the touch sensing unit TSU may be a base member encapsulating the display unit DU.

The main driver circuit 400 that generates touch coordinate data on the touch sensing areas may be located in the non-display area NDA or subsidiary area SBA of the display panel 100. Alternatively, the main driver circuit 400 that generates the touch coordinate data may be mounted on a separate circuit board 300. The main driver circuit 400 may be implemented as an integrated circuit (IC). For example, the main driver circuit 400 may supply touch driving signals to a plurality of touch electrodes arranged in a matrix in the touch sensing unit TSU and may sense a change in the capacitance between the plurality of touch electrodes. The main driver circuit 400 may determine whether a user's touch is input and may produce the touch coordinate data based on the amount of the change in the capacitance between the touch electrodes.

The data driver circuits 200 may be implemented as integrated circuits (IC) and may be located on the respective printed circuit films by the chip-on-glass (COG) technique, the chip-on-plastic (COP) technique, or ultrasonic bonding. The data driver circuits 200 may convert digital image data into analog data signals in response to a data control signal from the main driver circuit 400 and provide the data signals to the pixels. The data driver circuits 200 may provide data signals to the data lines connected to the pixels.

The gaze tracking processing unit 500 sequentially receives image data for images on the front side captured in real time by a built-in camera of the display panel 100, and divides and extracts eye images from the image data on the front side. Then, the gaze tracking processing unit 500 analyzes the eye movement direction and the gaze direction at least one per frame, and detects the user's gaze coordinate information. To do so, the gaze tracking processing unit 500 may detect an image of a corneal or reflected light of the corneal from the eye image data extracted from the image data on the front side, and may extract a position on the coordinates on the straight line on the front side facing the image of the corneal or the reflected light of the corneal, thereby extracting the gaze tracking coordinate information for the display panel 100. The method for extracting the gaze tracking coordinate information by detecting the eye position and the eye gaze direction is not limited to the method of extracting the corneal reflection described above. Any of a variety of eye and gaze tracking techniques well known in the art may be employed, such as a mapping matrix method based on an eye image. The gaze tracking processing unit 500 sequentially transmits to the main driver circuit 400 the gaze tracking coordinate information extracted at least once per frame.

The main driver circuit 400 may be implemented as an integrated circuit and may be mounted on the display panel 100 or on the circuit board 300 by the COG technique, the COP technique, or ultrasonic bonding. The main driver circuit 400 operates as a main processor and outputs gate and data control signals for driving the pixels of the image display unit DU.

In addition, the main driver circuit 400 divides and separates the image display area DA into a plurality of divided display areas based on the gaze tracking coordinate information received from the gaze tracking processing unit 500 at least once per frame. In doing so, the main driver circuit 400 defines a first divided display area on the image display area DA as a gaze area corresponding to gaze tracking coordinates. In addition, the main driver circuit 400 may define second and third divided display areas as one or more adjacent areas adjacent to the first divided display area which is the gaze area, and a fourth divided area as a distant area separated from the gaze area with the one or more adjacent areas therebetween, etc. In addition, the main driver circuit 400 may define the n^{th} divided display area, etc., as an important display area for displaying an image of an important feature depending on the characteristics of the displayed image, where n is a positive integer. The area, resolution and size of each of the first to nth divided display areas may be predetermined as the number of pixels arranged in a matrix depending on the area, resolution and size information of the entire image display area DA.

The main driver circuit 400 divides and aligns image data input from the outside at least once per frame into first to nth divided image data corresponding to the size and position of the first to nth divided display areas, respectively. At this time, the main driver circuit 400 analyzes the transmission rate of image data input from the outside, the number of transmission frames per unit time, and the driving frequency, to determine whether the image data input from the outside is still image data or moving image data and classify the features of the currently displayed image.

The main driver circuit 400 sequentially extracts dimming correction values for correcting image data for each of the divided display areas from each of the divided display areas based on the classification results of the features of the displayed image, and corrects and modulates the image data for each of the divided display areas with the respective dimming correction values.

The main driver circuit 400 aligns the corrected image data for each of the divided display areas at least once per frame and sequentially provides the corrected image data for each of the divided display areas to the data driver circuit 200 at least every horizontal line to control the image by the corrected image data for each of the divided display areas to be displayed in the respective divided display areas.

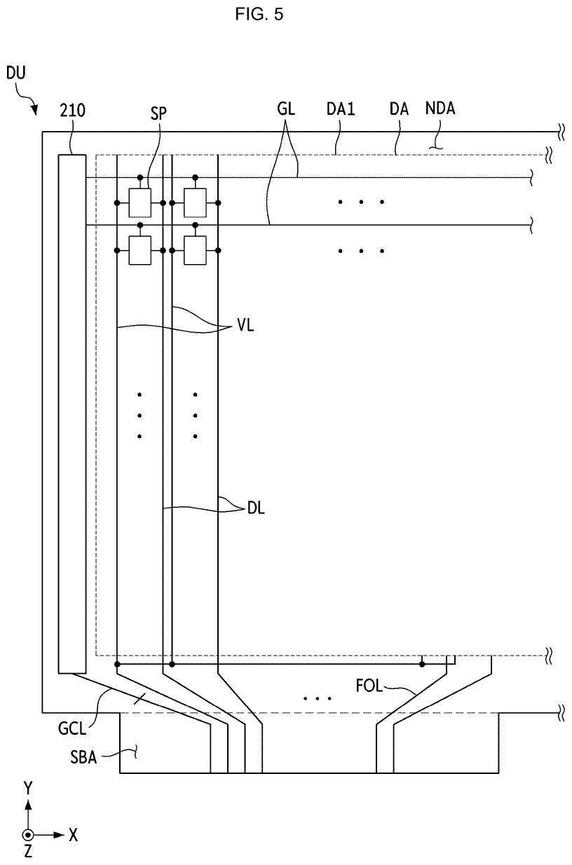

FIG. 5 is a view showing an example of a layout of a display panel according to some embodiments of the present disclosure. Specifically, FIG. 5 is a view showing a layout of a part of the image display area DA and the non-display area NDA of the display unit DU before the touch sensing unit TSU is formed.

The image display area DA may be defined as the central area including the center of the display panel 100. For example, the display area DA may include a plurality of pixels SP, a plurality of gate lines GL, a plurality of data lines DL, a plurality of voltage lines VL, etc. Each of the plurality of pixels SP may be defined as the minimum unit that outputs red light, green light, blue light, white light, etc.

The plurality of gate lines GL may provide the gate signals received from at least one gate driver 210 to the plurality of pixels SP. The plurality of gate lines GL may be extended in the first direction (x-axis direction) and may be spaced apart from each other in the second direction (y-axis direction) crossing the first direction (x-axis direction).

The plurality of data lines DL may provide the data voltages received from the data driver circuit 200 to the plurality of pixels SP. The plurality of data lines DL may be extended in the second direction (y-axis direction) and may be spaced apart from each other in the first direction (x-axis direction).

The plurality of voltage lines VL may apply the supply voltage received from the main driver circuit 400 or a separate power supply unit to the plurality of pixels SP. The supply voltage may be at least one of a driving voltage, an initialization voltage, or a reference voltage. The plurality of voltage lines VL may be extended in the second direction (y-axis direction) and may be spaced apart from each other in the first direction (x-axis direction).

The non-display area NDA is a peripheral area surrounding the display area DA, and may ultimately be defined as a bezel area. The non-display area NDA may include the gate driver 210, fan-out lines FOL, and gate control lines GCL. The gate driver 210 may generate a plurality of gate signals based on the gate control signal, and may sequentially supply the plurality of gate signals to the plurality of gate lines GL in an order (e.g., a set or predetermined order).

The fan-out lines FOL may be extended from the data driver circuit 200 to the image display area DA. The fan-out lines FOL may supply the data voltage received from the data driver circuit 200 to the plurality of data lines DL.

The gate control lines GCL may be extended from the main driver circuit 400 to the gate driver 210. The gate control lines GCL may supply the gate control signal received from the main driver circuit 400 to the gate driver 210.

The data driver circuit 200 may provide data voltages to the data lines DL through the fan-out lines FOL. The data voltages may be applied to the plurality of pixels SP, so that the display luminance of the plurality of pixels SP may be determined. On the other hand, the main driver circuit 400 may provide a gate control signal to the gate driver 210 through the gate control lines GCL to control the driving timing of the gate driver 210, i.e., the scan timing of the gate control lines GCL.

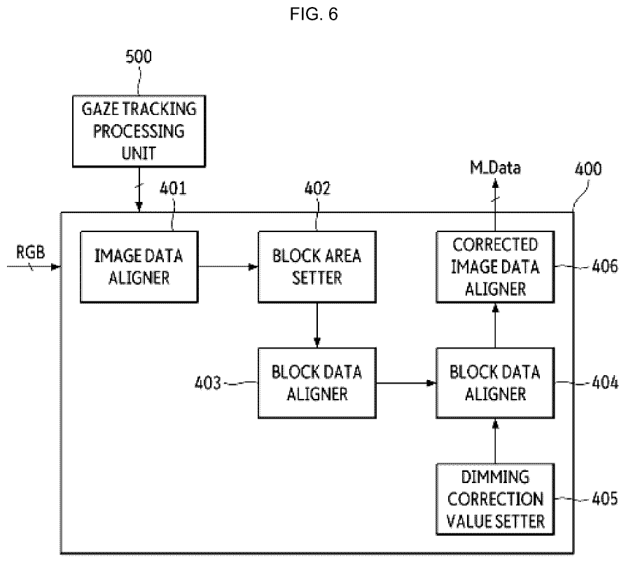

FIG. 6 is a block diagram showing in detail the elements of the main driver circuit shown in FIGS. 3 and 4.

Referring to FIG. 6, the main driver circuit 600 according to some embodiments includes an image data aligner 401, a block area setter 402, a block data aligner 403, a block data corrector 404, a dimming correction value setter 405, and a corrected image data aligner 406.

The image data aligner 401 of the main driver circuit 600 sequentially aligns image data RGB input from an external source such as a graphics card or a graphics system at least once per frame.

The block area setter 402 divides and separates the image display area DA of the display panel 100 into a plurality of divided display areas based on the gaze tracking coordinate information received from the gaze tracking processing unit 500 at least once per frame. Specifically, the block area setter 402 may define a first divided display area on the image display area DA as the gaze area corresponding to the gaze tracking coordinates. In addition, the block area setter 402 may define at least a second display area and at least a third display areas as one or more adjacent areas adjacent to the first divided display area, which is the gaze area. In addition, the block area setter 402 may define a fourth divided display area, etc., as a distant area separated from the gaze area with at least one adjacent area therebetween. In addition, the main driver circuit 400 may define the nth divided display area, etc., as an important display area for displaying an image of an important feature depending on the characteristics of the displayed image. The area, resolution and size of each of the first to nth divided display areas may be set or predetermined as the number of pixels arranged in a matrix (e.g., a set or predetermined matrix) depending on the area, resolution and size information of the entire image display area DA.

The block area setter 402 transmits to the block data aligner 403 block coordinate information on the first to nth divided display areas, which are defined as a gaze area, an adjacent area, a distant area and an important display area, respectively.

The block data aligner 403 divides and aligns the image data at least every frame aligned in the image data aligner 401 into a plurality of divided image data corresponding to the plurality of divided display areas separated in the block area setter 402, and classifies the image data RGB into still image and moving image features.

Specifically, the block data aligner 403 divides and aligns the image data at least every frame aligned in the image data aligner 401 into the first divided image data to the nth divided image data, which correspond to the sizes and locations of the first to nth divided display areas divided into the gaze area, the adjacent area, the distant area and the important display area, respectively.

In addition, the block data aligner 403 analyzes transmission format characteristics of the image data aligned in the image data aligner 401 such as the transmission rate, the number of transmission frames per unit time and the driving frequency, to determine whether the image data RGB input from the outside is still image data or moving image data and classify the features of the still image and moving image.

The block data corrector 404 sequentially extracts from the dimming correction value setter 405 dimming correction values for correcting divided image data for each of the divided display areas based on the results of classifying the features of the still image and moving image. Then, the block data corrector 404 corrects and modulates the divided image data for each of the divided display areas with the respective dimming correction values to generate the corrected image data for each of the divided display areas.

The corrected image data aligner 406 aligns the corrected image data for each of the divided display areas corrected by the dimming correction values in the block data corrector 404 at least every frame. Then, the corrected image data aligner 406 sequentially provides the data driver circuit 200 with the corrected image data for each of the divided display areas at least once per frame, to control the image by the corrected image data for each of the divided display areas to be displayed in the respective divided display areas. To this end, the corrected image data aligner 406 may include at least one frame memory or look-up table.

The dimming correction value setter 405 stores the dimming correction values for the divided image data for each of the divided display areas according to predetermined experimental values, separately for still image features and for moving image features. In addition, the dimming correction value setter 405 may share the dimming correction values for each of the divided display areas with the block data corrector 404.

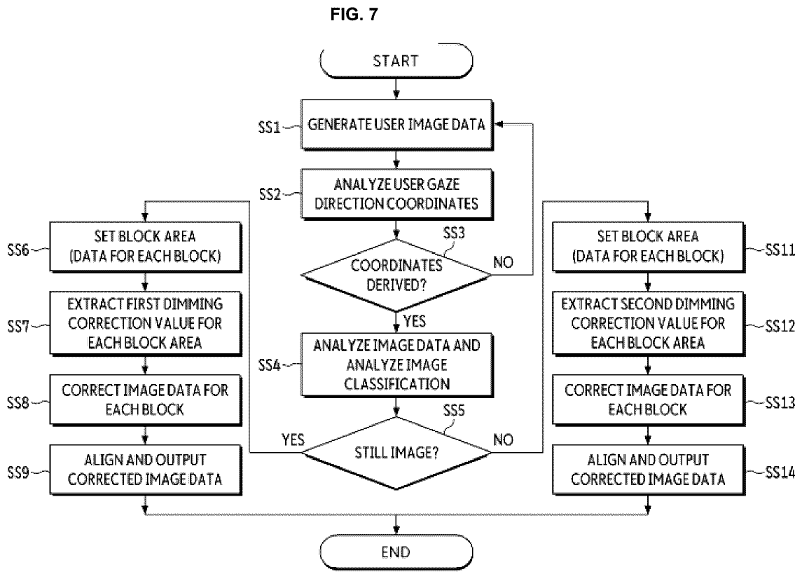

FIG. 7 is a flowchart for illustrating aspects of a method for correcting image data for each of the image display areas and modulating image display characteristics according to some embodiments of the present disclosure. Although FIG. 7 illustrates various operations in a method for correcting image data, according to some embodiments, embodiments according to the present disclosure are not limited thereto, and according to some embodiments, the method may include additional components or fewer components without departing from the spirit and scope of embodiments according to the present disclosure.

Referring to FIG. 7, the gaze tracking processing unit 500 sequentially receives image data for images on the front side captured in real time through a built-in camera of the display panel 100 (operation SS1). Then, the gaze tracking processing unit 500 analyzes the eye movement direction and gaze direction using the image data for the images on the front side, and detects tracking coordinate information of the user's gaze.

The gaze tracking processing unit 500 sequentially transmits to the main driver circuit 400 the gaze tracking coordinate information extracted at least once per frame (operation SS2).

If it fails to analyze eye recognition and gaze direction from the image data on the front side, the gaze tracking processing unit 500 receives the image data for the image on the front side again and detects tracking coordinate information of the user's gaze (operation SS3).

The image data aligner 401 of the main driver circuit 600 sequentially aligns image data RGB input from an external source at least every frame. In addition, the block data aligner 403 analyzes transmission format characteristics of the image data aligned in the image data aligner 401 such as the transmission rate, the number of transmission frames per unit time and the driving frequency, to classify the image data RGB input from the outside into the features of still image data and moving image data.

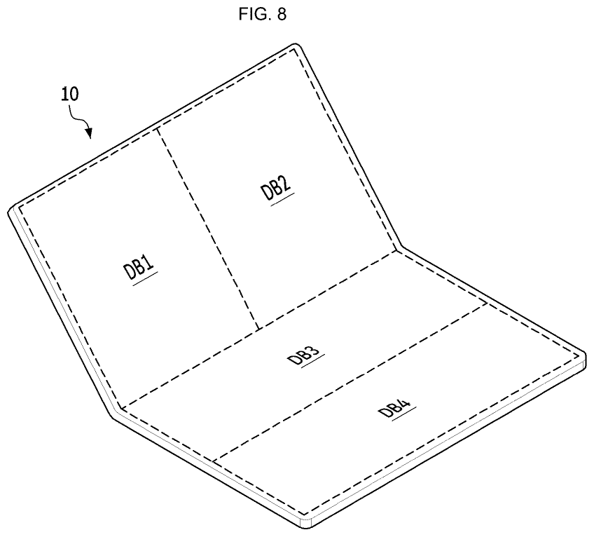

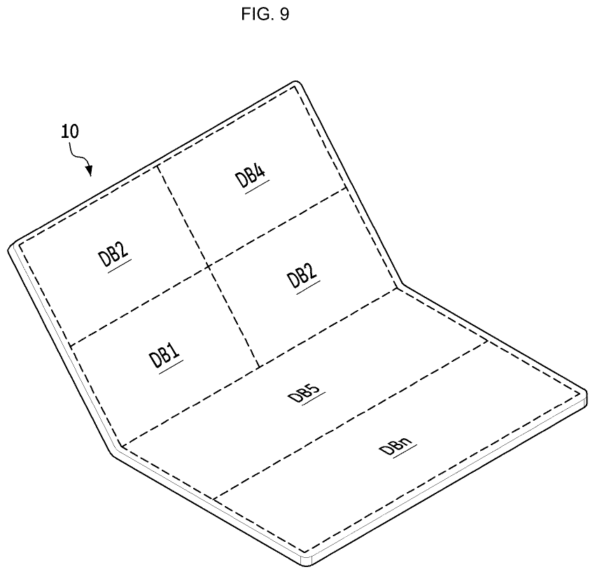

FIG. 8 is a perspective view showing a plurality of divided display areas separated on the image display areas of FIGS. 2 and 3 according to some embodiments. FIG. 9 is a perspective view showing a plurality of divided display areas separated on the image display areas of FIGS. 2 and 3 according to some embodiments.

Referring to FIGS. 8 and 9, the block area setter 402 of the main driver circuit 600 defines a first divided display area DB1 as a gaze area corresponding to the gaze tracking coordinates in the image display area DA of the display panel 100 based on the gaze tracking coordinate information received from the gaze tracking processing unit 500. In addition, the block area setter 402 of the main driver circuit 600 may define at least a second display area DB2 and at least a third display areas DB3 as one or more adjacent areas adjacent to the first divided display area DB1, which is the gaze area. In addition, the block area setter 402 may define a fourth divided display area DB4, etc., as a distant area separated from the gaze area with at least one adjacent area therebetween. In addition, the main driver circuit 400 may define the nth divided display area, etc., as an important display area for displaying an image of an important feature depending on the characteristics of the displayed image.

The block area setter 402 transmits to the block data aligner 403 block coordinate information on the first to nth divided display areas, which are defined as a gaze area, an adjacent area, a distant area and an important display area, respectively (operation SS6).

As described above, the block data aligner 403, by reflecting the information on still image or moving image features classified previously in the image data aligner 401, divides and aligns the image data of the still image into the first divided image data to the nth divided image data, which correspond to the sizes and locations of the gaze area, the adjacent area, the distant area and the important display area, respectively (operation SS6).

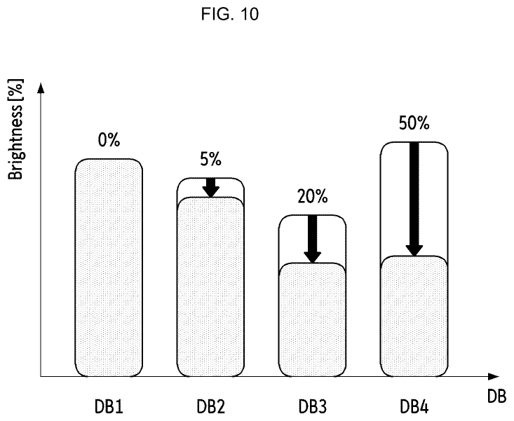

FIG. 10 is a graph showing reduction ratios of the brightness for different divided display areas according to still image features.

Referring to FIGS. 7 and 10, the block data corrector 404 sequentially extracts from the dimming correction value setter 405 still image dimming correction values for correcting the divided image data for each of the divided display areas based on the results of classifying the image as a still image (operation SS7). Then, the block data corrector 404 corrects and modulates the divided image data for each of the divided display areas with the respective still image dimming correction values to generate the corrected image data for each of the divided display areas.

The still image dimming correction values for the still image data stored in the dimming correction value setter 405 include still image dimming correction values of the adjacent areas and still image dimming correction values of the distant areas for correcting the divided image data of the adjacent area and the distant area, excluding the gaze area and the important display area.

Accordingly, the block data corrector 404 may subtract the still image dimming correction values from the grayscale value or luminance value of the divided image data of each of the adjacent area and the distant area or may multiply them by it, to lower the grayscale value or luminance value of the divided image data of each of the adjacent area and the distant area (operation SS8). The still image dimming correction values of the distant areas predetermined and stored may be larger than the still image dimming correction values of the adjacent areas according to predetermined experimental values. In other words, the still image dimming correction values of the distant areas and the still image dimming correction values of the adjacent areas have different weights. Accordingly, as shown in FIG. 10, the brightness gradation or luminance of the distant area may be lowered much more than the brightness gradation or luminance of the adjacent areas. The still image dimming correction values are predetermined such that they are larger than the moving dimming correction values according to the predetermined experimental values, and thus the gradation or luminance of the still image may be varied much more than that of the moving image. That is to say, the reduction ratio of the brightness gradation or luminance of the distant area may be larger than the reduction ratio of the brightness gradation or luminance of the adjacent areas.

The corrected image data aligner 406 aligns the corrected image data for each of the divided display areas corrected by the still image dimming correction values in the block data corrector 404 at least every frame. Then, the corrected image data aligner 406 sequentially provides the data driver circuit 200 with the corrected image data for each of the divided display areas at least once per frame, to control the image by the corrected image data for each of the divided display areas to be displayed in the respective divided display areas (operation SS9).

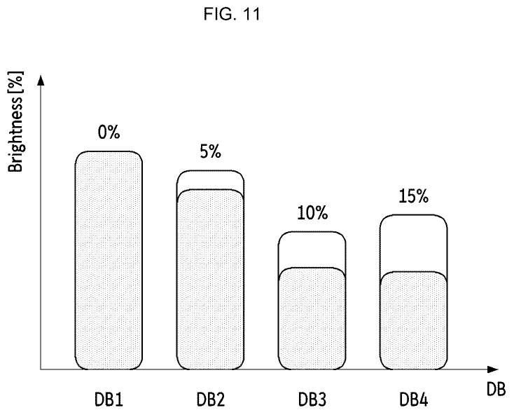

FIG. 11 is a graph showing reduction ratios of the brightness for different divided display areas according to still image features.

Referring to FIGS. 8 and 11, the block data aligner 403, by reflecting the information on moving image features classified previously in the image data aligner 401, divides and aligns the image data of the moving image into the first divided image data to the n^{th} divided image data, which correspond to the sizes and locations of the gaze area, the adjacent area, the distant area and the important display area, respectively (operation SS11).

The block data corrector 404 sequentially extracts from the dimming correction value setter 405 first moving image dimming correction values for correcting the divided image data for each of the divided display areas based on the results of classifying the features of moving image (operation SS12). Then, the block data corrector 404 corrects and modulates the divided image data for each of the divided display areas with the respective first moving image dimming correction values to generate the corrected image data for each of the divided display areas.

The moving image dimming correction values for the moving image data stored in the dimming correction value setter 405 include moving image dimming correction values of the adjacent areas and moving image dimming correction values of the distant areas for correcting the divided image data of the adjacent area and the distant area, excluding the gaze area and the important display area.

Accordingly, the block data corrector 404 may subtract the moving image dimming correction values from the grayscale value or luminance value of the divided image data of each of the adjacent area and the distant area or may multiply them by it, to lower the grayscale value or luminance value of the divided image data of each of the adjacent area and the distant area (operation SS13). The moving image dimming correction values of the remotely separated areas predetermined and stored may be larger than the moving image dimming correction values of the adjacent areas according to predetermined experimental values. As described above, the still image dimming correction values of the remotely separated areas and the still image dimming correction values of the adjacent areas have different weights. Accordingly, as shown in FIG. 12, the brightness gradation or luminance of the remotely separated area may be lowered much more than the brightness gradation or luminance of the adjacent areas. That is to say, the reduction ratio of the brightness gradation or luminance of the remotely separated area may be larger than the reduction rate of the brightness gradation or luminance of the adjacent areas.

The corrected image data aligner 406 aligns the corrected image data for each of the divided display areas corrected by the moving image dimming correction values in the block data corrector 404 at least every frame. Then, the corrected image data aligner 406 sequentially provides the data driver circuit 200 with the corrected image data for each of the divided display areas at least once per frame, to control the image by the corrected image data for each of the divided display areas to be displayed in the respective divided display areas (operation SS14).

According to the embodiments described above, the display device divides the entire image display area into a plurality of divided display areas based on results of tracking the user's gaze, and modulates the image display characteristics such as brightness and luminance for each of the plurality of divided display areas, thereby reducing power consumption for each of the display areas.

In addition, according to some embodiments of the present disclosure, by applying different weights to different divided display areas depending on whether the displayed image is a still image or a moving images (e.g., a video image) to modulate the image display characteristics, it is possible to increase the efficiency of saving power consumption while reducing the user's effort of perception.

In concluding the detailed description, those skilled in the art will appreciate that many variations and modifications can be made to the disclosed embodiments without substantially departing from the spirit and scope of embodiments according to the present disclosure, as defined by the appended claims, and their equivalents. Therefore, the disclosed embodiments of the present disclosure are used in a generic and descriptive sense only and not for purposes of limitation.

What is claimed is:

1. An image display device comprising:
a display panel configured to display an image in an image display area;
a gaze tracking processor configured to analyze image data for an image on a front side captured by a built-in camera of the display panel and to detect gaze tracking coordinate information; and
a main driver circuit configured to divide and separate the image display area into a plurality of divided display areas based on the gaze tracking coordinate information, and to modulate a grayscale value or a luminance value of the image data for at least one of the divided display areas according to still image or moving image features to thereby control an image display operation for at least one of the divided display areas.

2. The image display device of claim 1, wherein the gaze tracking processor is configured to divide and to extract eye image data from the image data for the image on the front side, and to detect an image of a corneal or a reflected image of the corneal from the eye image data, and
wherein the gaze tracking processor is configured to extract a coordinate position on a straight line on the front side facing the image of the corneal or the reflected image of the corneal to extract the gaze tracking coordinate information for the display panel.

3. The image display device of claim 2, wherein the main driver circuit is configured to divide and separate the image display area into a gaze area corresponding to the gaze tracking coordinate information, at least one adjacent area adjacent to the gaze area, at least one distant area separated from the gaze area with the at least one adjacent area therebetween, and at least one important display area configured to display an image of an important feature depending on characteristics of the displayed image, and
wherein an area, a resolution and a size of each of the gaze area, the at least one adjacent area, the at least one distant area and the at least one important display area are predetermined with a number of pixels arranged in a matrix according to overall area, resolution and size information of the image display area.

4. The display device of claim 3, wherein the main driver circuit is configured to:
analyze at least one image transmission format of the image data input from an outside among a transmission rate, a number of transmission frames per unit time and a driving frequency, to classify the image data input from the outside into features of the still image and moving image;
divide and align the image data input from the outside at least one per frame into divided image data corresponding to a size and position of each of the gaze area, the at least one adjacent area, the at least one distant area and the at least one important display area;
sequentially extract still image or moving image dimming correction values for correcting the divided image data for each of the divided display areas based on results of classifying the features of still image or moving image; and
calculate a grayscale value or luminance value of the divided image data for each of the divided display areas with the respective still image or moving image dimming correction values to correct and modulate it.

5. The image display device of claim 1, wherein the main driver circuit comprises:
a block area setter configured to divide and separate the image display area into the plurality of divided display areas based on the gaze tracking coordinate information;
a block data aligner configured to divide and align image data at least every frame into a plurality of divided image data corresponding to the divided display areas, and to classify the image data into features of still image and moving image;
a block data corrector configured to sequentially extract dimming correction values for correcting the divided image data for at least one divided display area among the plurality of divided display areas according to the results of classifying the features of still image and moving image, and to correct and modulate the divided image data for the at least one divided display area with the respective dimming correction values; and
a corrected image data aligner configured to sequentially provide a data driver circuit with the corrected image data for the at least one the divided display area corrected by the dimming correction values, to control an image by the corrected image data for the at least one divided display area to be displayed in the respective divided display area.

6. The image display device of claim 5, wherein the block area setter is configured to divide and separate the image display area into a gaze area corresponding to the gaze tracking coordinate information, at least one adjacent area adjacent to the gaze area, at least one distant area separated from the gaze area with the at least one adjacent area therebetween, and at least one important display area that displays an image of an important feature depending on characteristics of the displayed image, and
wherein an area, a resolution and a size of each of the gaze area, the at least one adjacent area, the at least one distant area and the at least one important display area are predetermined with a number of pixels arranged in a matrix according to overall area, resolution and size information of the image display area.

7. The display device of claim 6, wherein the block data aligner is configured to:
divide and align the image data at least every frame into the divided image data corresponding to a size and location of each of the gaze area, the at least one adjacent area, the at least one distant area, and the at least one important display area; and
analyze at least one image transmission format among a transmission rate, a number of transmission frames per unit time and a driving frequency for the image data at least every frame to classify the image data into features of still image and moving image.

8. The image display device of claim 6, wherein the block data corrector is configured to, in response to results of classifying as a still image by the block data aligner, subtract the still image dimming correction values from a grayscale value or luminance value of each of the divided image data of the at least one adjacent area and the at least one distant area or multiply them by it, to generate corrected image data with a lowered grayscale value or luminance value of the divided image data of each of the at least one adjacent area and the at least one distant area.

9. The image display device of claim 8, wherein the still image dimming correction values comprise a still image dimming correction value of adjacent areas for correcting divided image data of the at least one adjacent area, and still image dimming correction values of distant areas for correcting divided image data of the at least one distant area, and
wherein the still image dimming correction values of the distant areas are predetermined to be larger than the still image dimming correction values of the adjacent areas according to predetermined experimental values.

10. The image display device of claim 8, wherein the block data corrector is configured to, in response to results of classifying as a moving image by the block data aligner, subtract moving image dimming correction values from a grayscale value or luminance value of each of the divided image data of the at least one adjacent area and the at least one distant area or multiplies them by it, to generate corrected image data with a lowered grayscale value or luminance value of the divided image data of each of the at least one adjacent area and the at least one distant area, and
wherein the still image dimming correction values are predetermined to be larger than the moving image dimming correction values according to predetermined experimental values.

11. An image display device comprising:
a display panel configured to display an image in an image display area;
a touch sensor on a front surface of the display panel to detect a user's touch;
a gaze tracking processor configured to analyze image data on an image on a front side captured by a built-in camera of the display panel and detecting the user's gaze tracking coordinate information; and
a main driver circuit configured to divide and separate the image display area into a plurality of divided display areas comprising a gaze area corresponding to the gaze tracking coordinates, at least one adjacent area adjacent to the gaze area, at least one distant area separated from the gaze area with the at least one adjacent area therebetween, and at least one important display area displaying an image of an important feature depending on characteristics of the image, and modulates image data for at least one divided display area angle the divided display areas to control an image display operation for the at least one divided display area.

12. The image display device of claim 11, wherein the main driver circuit comprises:
a block area setter configured to divide and separate the image display area into the plurality of divided display areas based on the gaze tracking coordinate information;
a block data aligner configured to divide and align image data at least every frame into a plurality of divided image data corresponding to the divided display areas, and to classify the image data into features of still image and moving image;
a block data corrector configured to sequentially extract dimming correction values for correcting the divided image data for at least one divided display area among the plurality of divided display areas according to the results of classifying the features of still image and moving image, and to correct and modulate the divided image data for the at least one divided display area with the respective dimming correction values; and
a corrected image data aligner configured to sequentially provide a data driver circuit with the corrected image data for the at least one the divided display area corrected by the dimming correction values, to control an image by the corrected image data for the at least one divided display area to be displayed in the respective divided display area.

13. The image display device of claim 12, wherein an area, a resolution and a size of each of the gaze area, the at least one adjacent area, the at least one distant area and the at least one important display area are predetermined with a number of pixels arranged in a matrix according to overall area, resolution and size information of the image display area.

14. The image display device of claim 13, wherein the block data corrector is configured to, in response to results of classifying as a still image by the block data aligner, subtract the still image dimming correction values from a grayscale value or luminance value of each of the divided image data of the at least one adjacent area and the at least one distant area or multiplies them by it, to generate corrected image data with a lowered grayscale value or luminance value of the divided image data of each of the at least one adjacent area and the at least one distant area.

15. The image display device of claim 14, wherein the still image dimming correction values comprise a still image dimming correction value of adjacent areas for correcting divided image data of the at least one adjacent area, and still image dimming correction values of distant areas for correcting divided image data of the at least one distant area, and
wherein the still image dimming correction values of the distant areas are predetermined to be larger than the still image dimming correction values of the adjacent areas according to predetermined experimental values.

16. The image display device of claim 14, wherein the block data corrector is configured to, in response to results of classifying as a moving image by the block data aligner, subtract moving image dimming correction values from a grayscale value or luminance value of each of the divided image data of the at least one adjacent area and the at least one distant area or multiplies them by it, to generate corrected image data with a lowered grayscale value or luminance value of the divided image data of each of the at least one adjacent area and the at least one distant area, and
wherein the still image dimming correction values are predetermined to be larger than the moving image dimming correction values according to predetermined experimental values.

17. An electronic device including an image display device,
the image display device comprising:
a display panel configured to display an image in an image display area;
a gaze tracking processor configured to analyze image data for an image on a front side captured by a built-in camera of the display panel and to detect gaze tracking coordinate information; and
a main driver circuit configured to divide and separate the image display area into a plurality of divided display areas based on the gaze tracking coordinate information, and to modulate a grayscale value or a luminance value of the image data for at least one of the divided display areas according to still image or moving image features to thereby control an image display operation for at least one of the divided display areas.

18. The electronic device of claim 17, wherein the electronic device is one of a mobile phone, a smart phone, a tablet personal computer (PC), a mobile communications terminal, an electronic notebook, an electronic book, a portable multimedia player (PMP), a navigation device and a ultra mobile PC (UMPC), a television, a laptop computer, a monitor, an electronic billboard, or an Internet of Things (IOT) device.
